(19) United States
(12) Patent Application Publication
(10) Pub. No.: US 2009/0085807 A1
(43) Pub. Date: Apr. 2, 2009

(54) COIL ARRAY FOR AN ELECTROMAGNETIC TRACKING SYSTEM

(75) Inventor: Peter Traneus Anderson, Andover, MA (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/865,822

(22) Filed: Oct. 2, 2007

(51) Int. Cl. G01S 5/00; H01Q 7/08

(52) U.S. Cl. 342/450; 343/788

(57) ABSTRACT

An electromagnetic tracking system comprising a transmitter coil array with two or more transmitter coils and a receiver coil array with one or more ferrite rod antennas. A transmitter or receiver coil array for an electromagnetic tracking system comprising a plurality of ferrite rod antennas positioned on a plane at different locations, with different orientations, and pointing in different directions.

### BACKGROUND OF THE INVENTION

This disclosure relates generally to an electromagnetic tracking system that uses electromagnetic fields to determine the position and orientation of an object, and more particularly to a coil array of ferrite rod antennas for an electromagnetic tracking system.

Electromagnetic tracking systems have been used in various industries and applications to provide position and orientation information relating to objects. For example, electromagnetic tracking systems may be useful in aviation applications, motion sensing applications, retail applications, and medical applications. In medical applications, electromagnetic tracking systems have been used to provide an operator (e.g., a physician, surgeon, or other medical practitioner) with information to assist in the precise and rapid positioning of a medical device, implant or instrument located in or near a patient's body during image-guided surgery. An electromagnetic tracking system provides positioning and orientation information for a medical device, implant or instrument with respect to the patient or a reference coordinate system. An electromagnetic tracking system provides intraoperative tracking of the precise location of a medical device, implant or instrument in relation to multidimensional images of a patient's anatomy.

An electromagnetic tracking system uses visualization tools to provide a medical practitioner with co-registered views of a graphical representation of the medical device, implant or instrument with pre-operative or intraoperative images of the patient's anatomy. In other words, an electromagnetic tracking system allows a medical practitioner to visualize the patient's anatomy and track the position and orientation of a medical device, implant or instrument with respect to the patient's anatomy. As the medical device, implant or instrument is positioned with respect to the patient's anatomy, the displayed image is continuously updated to reflect the real-time position and orientation of the medical device, implant or instrument. The combination of the image and the representation of the tracked medical device, implant or instrument provide position and orientation information that allows a medical practitioner to manipulate a medical device, implant or instrument to a desired location with an accurate position and orientation.

Generally, an electromagnetic tracking system may include an electromagnetic transmitter with an array of one or more transmitter coils, an electromagnetic receiver with an array of one or more receiver coils, electronics to generate a current drive signal for the one or more transmitter coils and to measure the mutual inductances between transmitter and receiver coils, and a computer to calculate the position and orientation of the receiver coil array with the respect to the transmitter coil array, or vice versa. An alternating current drive signal is provided to each coil of the electromagnetic transmitter, generating an electromagnetic field being emitted from each coil of the electromagnetic transmitter. The electromagnetic field generated by each coil in the electromagnetic transmitter induces a voltage in each coil of the electromagnetic receiver. These voltages are indicative of the mutual inductances between the coils of the electromagnetic transmitter and the coils of the electromagnetic receiver. These voltages and mutual inductances are sent to a computer for processing. The computer uses these measured voltages and mutual inductances to calculate the position and orientation of the coils of the electromagnetic transmitter relative to the coils of the electromagnetic receiver, or the coils of the electromagnetic receiver relative to the coils of the electromagnetic transmitter, including six degrees of freedom (x, y, and z measurements, as well as roll, pitch and yaw angles).

Preferably, the mutual inductances between coils of the electromagnetic transmitter and the electromagnetic receiver may be measured without inaccuracies. However, electromagnetic tracking systems are known to suffer from accuracy degradation due to electromagnetic field distortion caused by the presence of an uncharacterized metal distorter within the tracking volume or electromagnetic fields of the electromagnetic tracking system. The presence of an uncharacterized metal distorter within the tracking volume of the electromagnetic tracking system may create distortion of the electromagnetic fields of the electromagnetic tracking system. This distortion may cause inaccuracies in tracking the position and orientation of medical devices and instruments by causing inaccuracies in position and orientation calculations of the coils of the electromagnetic transmitter relative to the coils of the electromagnetic receiver, or the coils of the electromagnetic receiver relative to the coils of the electromagnetic transmitter.

The size and profile of the electromagnetic transmitters and receivers are continuing to get smaller and smaller, and trending towards small packages. Such small electromagnetic transmitters and receivers must still provide sufficient electromagnetic field generation signal strength, a high quality factor (Q), and sufficient signal sensitivity.

Therefore, there is a need for a small, low profile coil array for an electromagnetic tracking system.

### BRIEF DESCRIPTION OF THE INVENTION

In an embodiment, an electromagnetic tracking system comprising at least one transmitter assembly including one or more transmitter coils; at least one receiver assembly communicating with and receiving signals from the at least one transmitter assembly, the at least one receiver assembly including at least one ferrite rod antenna; and electronics coupled to and communicating with the at least one transmitter assembly and the at least one receiver assembly for calculating the position and orientation of an object to be tracked.

In an embodiment, a receiver coil array for an electromagnetic tracking system comprising a plurality of ferrite rod antennas positioned on a plane at different locations, with different orientations, and pointing in different directions.

In an embodiment, a transmitter coil array for an electromagnetic tracking system comprising at least one ferrite rod antenna.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram illustrating an exemplary embodiment of an electromagnetic tracking system;

FIG. 2 is a schematic diagram illustrating an exemplary embodiment of a ferrite rod antenna;

FIG. 3 is a schematic diagram illustrating an exemplary embodiment of a tuned ferrite rod antenna;

FIG. 4 is a schematic diagram illustrating an exemplary embodiment of a ferrite rod antenna receiver array for an electromagnetic tracking system;

FIG. 5 is a schematic diagram illustrating an exemplary embodiment of a ferrite rod antenna receiver array for an electromagnetic tracking system;

FIG. 6 is a schematic diagram illustrating an exemplary embodiment of a ferrite rod antenna receiver array for an electromagnetic tracking system; and

FIG. 7 is a schematic diagram illustrating an exemplary embodiment of a ferrite rod antenna receiver array for an electromagnetic tracking system.

### DETAILED DESCRIPTION OF THE INVENTION

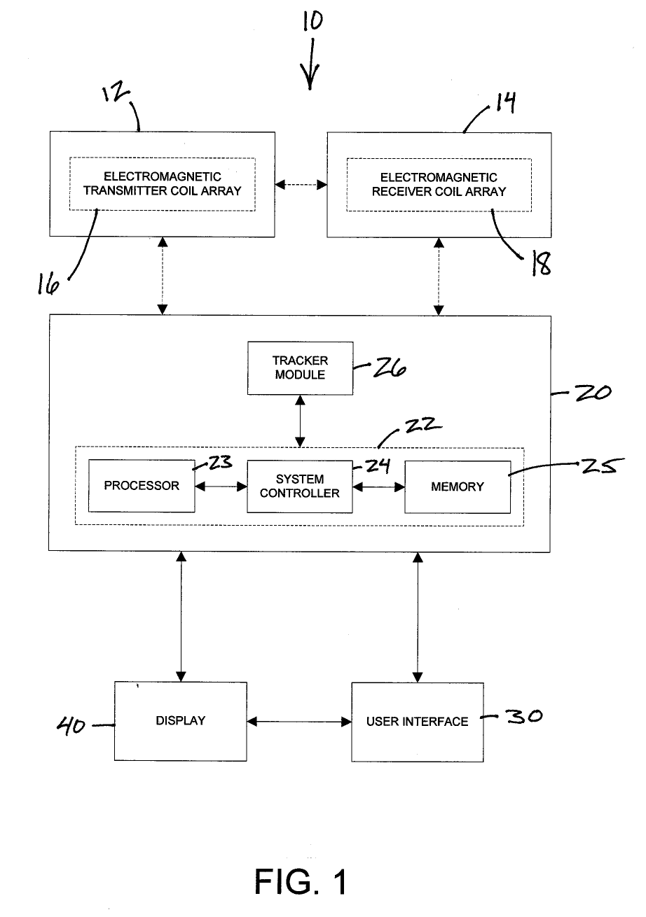

Referring now to the drawings, FIG. 1 is a block diagram illustrating an exemplary embodiment of an electromagnetic tracking system 10. The electromagnetic tracking system 10 comprises at least one electromagnetic transmitter assembly 12 with an electromagnetic transmitter coil array 16 having one or more transmitter coils and at least one electromagnetic receiver assembly 14 with an electromagnetic receiver coil array 16 having one or more ferrite rod antennas. The one or more ferrite rod antennas are configured to provide a small, compact, low profile electromagnetic receiver coil array. The electromagnetic tracking system 10 provides position and orientation data that spatially relates the one or more ferrite rod antennas to the one or more transmitter coils, or vice versa.

The electromagnetic tracking system 10 further comprises a tracker workstation 20 coupled to and receiving data from the at least one electromagnetic transmitter assembly 12 and the at least one electromagnetic receiver assembly 14, a user interface 30 coupled to the tracker workstation 20, and a display 40 for visualizing imaging and tracking data. The tracker workstation 20 includes a tracking system computer 22 and a tracker module 26. The tracking system computer 22 includes at least one processor 23, a system controller 24 and memory 25.

The one or more coils of the electromagnetic transmitter coil array 16 may be built with various coil architectures. These coils may be single coils, industry-standard-coil-architecture (ISCA) type coils, multiple coils, or an array of coils. ISCA type coils are defined as three approximately collocated, approximately orthogonal, and approximately dipole coils. In other words, an ISCA configuration for the electromagnetic transmitter coil array 16 would include a three-axis dipole coil transmitter. In the ISCA configuration, the transmitter coils are configured such that the three coils (i.e., coil trios) exhibit the same effective area, are oriented orthogonally to one another, and are centered at the same point.

In an exemplary embodiment, the one or more coils of the electromagnetic transmitter coil array 16 may be characterized as single dipole coils that emit magnetic fields when a current is passed through the coils. Those skilled in the art will appreciate that multiple electromagnetic field generating coils may be used in coordination to generate multiple magnetic fields. The one or more ferrite rod antennas of the electromagnetic receiver coil array 18 may be characterized as single dipole coils and detect the magnetic fields emitted by the coils of the electromagnetic transmitter coil array 16. When a current is applied to the one or more coils of the electromagnetic transmitter coil array 16, the magnetic fields generated by the coils may induce a voltage into each ferrite rod antenna of the electromagnetic receiver coil array 18. The induced voltage is indicative of the mutual inductance between the one or more coils of the electromagnetic coil array 16. Thus, the induced voltage across each ferrite rod antenna of the electromagnetic receiver coil array 18 is detected and processed to determine the mutual inductance between each coil of the electromagnetic transmitter coil array 16 and each ferrite rod antenna of the electromagnetic receiver coil array 18.

The magnetic field measurements may be used to calculate the position and orientation of the electromagnetic receiver coil array 18 with respect to the electromagnetic transmitter coil array 16, or vice versa according to any suitable method or system. The detected magnetic field measurements are digitized by electronics that may be included with the at least one electromagnetic receiver assembly 14 or the tracker module 26. The magnetic field measurements or digitized signals may be transmitted from the at least one electromagnetic receiver assembly 14 to the tracking system computer 22 using wired or wireless communication protocols and interfaces. The digitized signals received by the tracking system computer 22 represent magnetic field information detected by the at least one electromagnetic receiver assembly 14. The digitized signals are used to calculate position and orientation information of the at least one electromagnetic receiver assembly 14 or the at least one electromagnetic transmitter assembly 12.

The position and orientation information is used to register the location of the at least one electromagnetic receiver assembly 14 or the at least one electromagnetic transmitter assembly 12 to acquired imaging data from an imaging system. The position and orientation data is visualized on the display 40, showing in real-time the location of the at least one electromagnetic transmitter assembly 12 or the at least one electromagnetic receiver assembly 14 on pre-acquired or real-time images from the imaging system. The acquired imaging data may be from a computed tomography (CT) imaging system, a magnetic resonance (MR) imaging system, a positron emission tomography (PET) imaging system, an ultrasound imaging system, an X-ray imaging system, or any suitable combination thereof. All six degrees of freedom (three of position (x, y, z) and three of orientation (roll, pitch, yaw)) of the at least one electromagnetic receiver assembly 14 or the at least one electromagnetic transmitter assembly 12 may be determined and tracked.

In an exemplary embodiment, the one or more coils of the electromagnetic transmitter coil array 16 and the one or more ferrite rod antennas of the electromagnetic receiver coil array 18 are either precisely manufactured or precisely characterized during manufacture to obtain mathematical models of the one or more coils in the electromagnetic transmitter coil array 16 and the one or more ferrite rod antennas of the electromagnetic receiver coil array 18. From the magnetic field measurements and mathematical models of the one or more coils and one or more ferrite rod antennas, the position and orientation of the at least one electromagnetic receiver assembly 14 with respect to the at least one electromagnetic transmitter assembly 12 may be determined. Alternatively, the position and orientation of the at least one electromagnetic transmitter assembly 12 with respect to the at least one electromagnetic receiver assembly 14 may be determined.

In an exemplary embodiment, the at least one electromagnetic transmitter assembly 12 may be a battery-powered wireless transmitter assembly, a passive transmitter assembly, or a wired transmitter assembly. In an exemplary embodiment, the at least one electromagnetic receiver assembly 14 may be a battery-powered wireless receiver assembly, a passive receiver assembly, or a wired receiver assembly.

In an exemplary embodiment, the tracker module 26 may include drive circuitry configured to provide a drive current to each coil of the at least one electromagnetic transmitter coil array 16. By way of example, a drive current may be supplied by the drive circuitry to energize a coil of the at least one electromagnetic transmitter coil array 16, and thereby generate an electromagnetic field that is detected by a ferrite rod antenna of the electromagnetic receiver coil array 18. The drive current may be comprised of a periodic waveform with a given frequency (e.g., a sine wave, cosine wave or other periodic signal). The drive current supplied to a coil will generate an electromagnetic field at the same frequency as the drive current. The electromagnetic field generated by a coil of the electromagnetic transmitter coil array 16 induces a voltage indicative of the mutual inductance in a ferrite rod antenna of the electromagnetic receiver coil array 18. In an exemplary embodiment, the tracker module 26 may include receiver data acquisition circuitry for receiving voltage and mutual inductance data from the at least one electromagnetic receiver assembly 14.

In an exemplary embodiment, the tracking system computer 22 may include at least one processor 23, such as a digital signal processor, a CPU, or the like. The processor 23 may process measured voltage and mutual inductance data from the at least one electromagnetic receiver assembly 14 to track the position and orientation of the at least one electromagnetic transmitter assembly 12 or the at least one electromagnetic receiver assembly 14.

The at least one processor 23 may implement any suitable algorithm(s) to use the measured voltage signal indicative of the mutual inductance to calculate the position and orientation of the at least one electromagnetic receiver assembly 14 relative to the at least one electromagnetic transmitter assembly 12, or the at least one electromagnetic transmitter assembly 12 relative to the at least one electromagnetic receiver assembly 14. For example, the at least one processor 23 may use ratios of mutual inductance between each coil of the at least one electromagnetic receiver assembly 14 and each coil of the at least one electromagnetic transmitter assembly 12 to triangulate the relative positions of the coils. The at least one processor 23 may then use these relative positions to calculate the position and orientation of the at least one electromagnetic transmitter assembly 12 or the at least one electromagnetic receiver assembly 14.

In an exemplary embodiment, the tracking system computer 22 may include a system controller 24. The system controller 24 may control operations of the electromagnetic tracking system 10.

In an exemplary embodiment, the tracking system computer 22 may include memory 25, which may be any processor-readable media that is accessible by the components of the tracker workstation 20. In an exemplary embodiment, the memory 25 may be either volatile or non-volatile media. In an exemplary embodiment, the memory 25 may be either removable or non-removable media. Examples of processor-readable media may include (by way of example and not limitation): RAM (Random Access Memory), ROM (Read Only Memory), registers, cache, flash memory, storage devices, memory sticks, floppy disks, hard drives, CD-ROM, DVD-ROM, network storage, and the like.

In an exemplary embodiment, the user interface 30 may include devices to facilitate the exchange of data and workflow between the system and the user. In an exemplary embodiment, the user interface 30 may include a keyboard, a mouse, a joystick, buttons, a touch screen display, or other devices providing user-selectable options, for example. In an exemplary embodiment, the user interface 30 may also include a printer or other peripheral devices.

In an exemplary embodiment, the display 40 may be used for visualizing the position and orientation of a tracked object with respect to a processed image from an imaging system.

In an exemplary embodiment, the at least one electromagnetic receiver assembly 14 may be attached to a medical device, implant or instrument to be tracked and the at least one electromagnetic transmitter assembly 12 may generate at least one electromagnetic field to be received by the at least one electromagnetic receiver assembly 14. The electromagnetic tracking system 10, may track the position and orientation of the medical device, implant or instrument 16 during a medical procedure.

In an exemplary embodiment, the at least one electromagnetic transmitter assembly 12 may be attached to a medical device, implant or instrument to be tracked and the at least one electromagnetic receiver assembly 14 may be positioned within at least one electromagnetic field generated by the at least one electromagnetic transmitter assembly 12. The electromagnetic tracking system 10 enables a medical professional to continually track the position and orientation of the medical device, implant or instrument 16 during a medical procedure.

In an exemplary embodiment, the at least one electromagnetic transmitter and receiver assemblies 12, 14 may be wireless, with the coils being driven self-contained circuitry, data acquisitions being performed by self-contained circuitry, and power being provided by a self-contained power source.

In an exemplary embodiment, the at least one electromagnetic transmitter assembly 12 may be enclosed within a housing. In an exemplary embodiment, the at least one electromagnetic receiver assembly 12 may be enclosed within a housing.

Notwithstanding the description of the exemplary embodiment of the electromagnetic tracking system 10 illustrated FIG. 1, alternative system architectures may be substituted without departing from the scope of the invention.

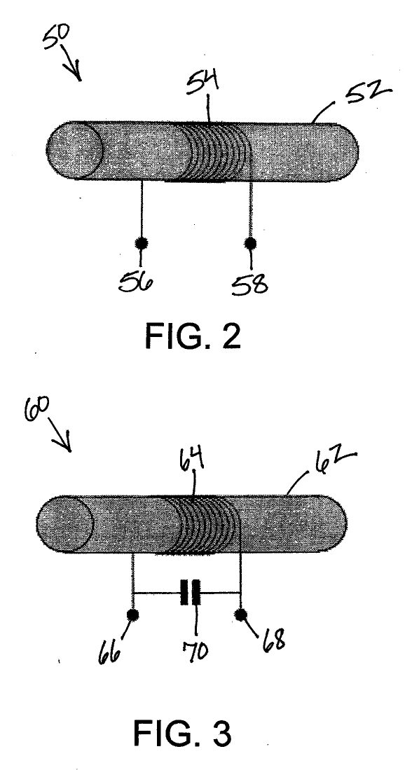

FIG. 2 is a schematic diagram illustrating an exemplary embodiment of a ferrite rod antenna 50. The ferrite rod antenna 50 includes a rod 52 made of ferrite, an iron based high permeability magnetic material, with at least one turn of an electrically conductive coil 54 wound around the ferrite rod 52. The ends 56, 58 of the coil 54 form the ferrite rod antenna's leads. The ferrite rod antenna 50 may be used as an electromagnetic receiver for an electromagnetic tracking system. The ferrite rod antenna 50 is very small and compact. A plurality of ferrite rod antennas 50 may be used to build a compact, low profile array of coils for use as an electromagnetic receiver coil array. The ferrite rod antenna 50 provides a high Q while simultaneously exhibiting sufficient radiated signal sensitivity.

In an exemplary embodiment, the ferrite rod antenna 50 may also be used as an electromagnetic transmitter for an electromagnetic tracking system when the power level to be transmitted is low.

FIG. 3 is a schematic diagram illustrating an exemplary embodiment of a tuned ferrite rod antenna 60. The ferrite rod antenna 60 includes a rod 62 made of ferrite, an iron based high permeability magnetic material, with at least one turn of an electrically conductive coil 64 wound around the ferrite rod 62. The ends 66, 68 of the coil 64 form the ferrite rod antenna's leads. The ferrite rod antenna 60 may be brought into resonance by adding a variable tuning capacitor 70 to the leads 66, 68 of the coil 64. The ferrite rod antenna 60 may be used as an electromagnetic receiver for an electromagnetic tracking system. The ferrite rod antenna 60 is very small and compact. A plurality of ferrite rod antennas 60 may be used to build a compact, low profile array of coils for use as an electromagnetic receiver coil array. The ferrite rod antenna 60 provides a high Q while simultaneously exhibiting sufficient radiated signal sensitivity.

In an exemplary embodiment, the ferrite rod antenna 60 may also be used as an electromagnetic transmitter for an electromagnetic tracking system when the power level to be transmitted is low.

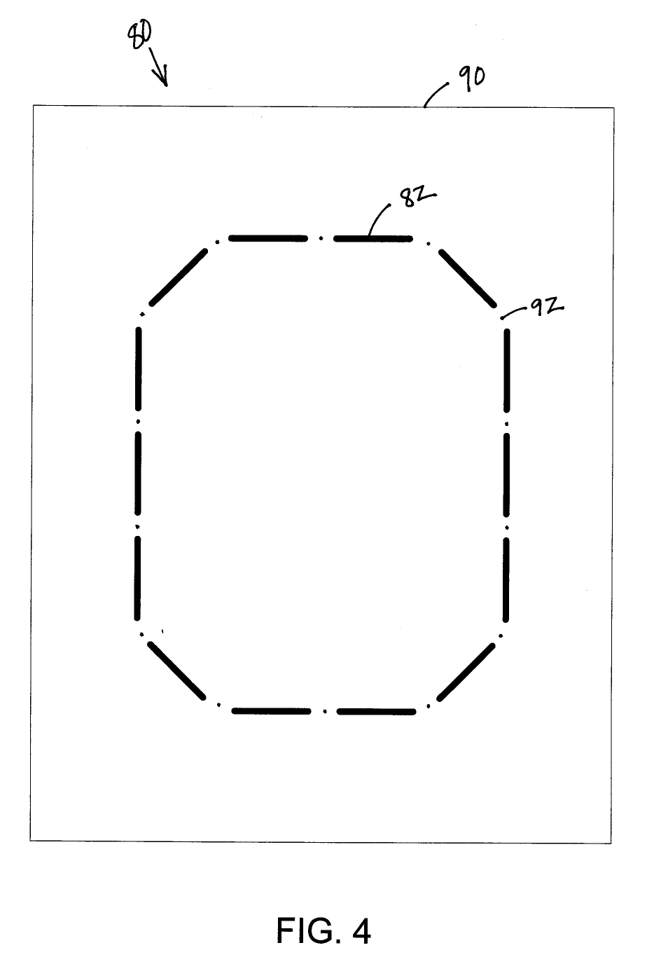

FIGS. 4-7 illustrate various exemplary embodiments of ferrite rod antenna receiver arrays for an electromagnetic tracking system. A plurality of ferrite rod antennas may be used to build a compact, low profile array of coils for use as an electromagnetic receiver coil array. There are an endless number of different array configurations or arrangements. The ferrite rod antennas may be arranged in the same plane, at different locations, with different orientations, and pointing in different directions.

FIG. 4 is a schematic diagram illustrating an exemplary embodiment of a ferrite rod antenna receiver array 80 for use as an electromagnetic receiver coil array for an electromagnetic tracking system. The ferrite rod antenna receiver array 80 comprises a plurality of ferrite rod antennas 82 that are horizontally arranged and attached to a plane 90. Each ferrite rod antenna 82 may include a ferrite rod with at least one turn of an electrically conductive coil wound around the rod as shown in FIG. 2. The ends of the coil form the antenna's leads and may be used to secure the ferrite rod antenna 82 to the plane 90. In an exemplary embodiment, the ferrite rod antenna 82 may further include a capacitor attached to the leads of the coil as shown in FIG. 3.

In the exemplary embodiment shown in FIG. 4, the plurality of ferrite rod antennas 82 are arranged horizontally on the plane 90 to form a rectangularly shaped receiver array. The ferrite rod antennas 82 are arranged horizontally on the same plane 90, but at different locations, with different orientations, and pointing in different directions. The ferrite rod antennas 82 may be attached to the plane 90 with an adhesive, epoxy, glue, solder, or other attachment mechanism.

In an exemplary embodiment, the plane 90 may be a printed circuit board (PCB). The PCB may be a single layer or a multi-layer PCB. The PCB includes at least one layer with conductors on one or both sides, or even on inner layers, and including a plurality of conductor through holes 92 for mounting the plurality of ferrite rod antennas 82 to the PCB. The PCB may be made of a material that is flexible or rigid. In an exemplary embodiment, the leads of the ferrite rod antennas 82 may be inserted into the conductor through holes 92 and soldered in place to secure the ferrite rod antennas 82 to the PCB.

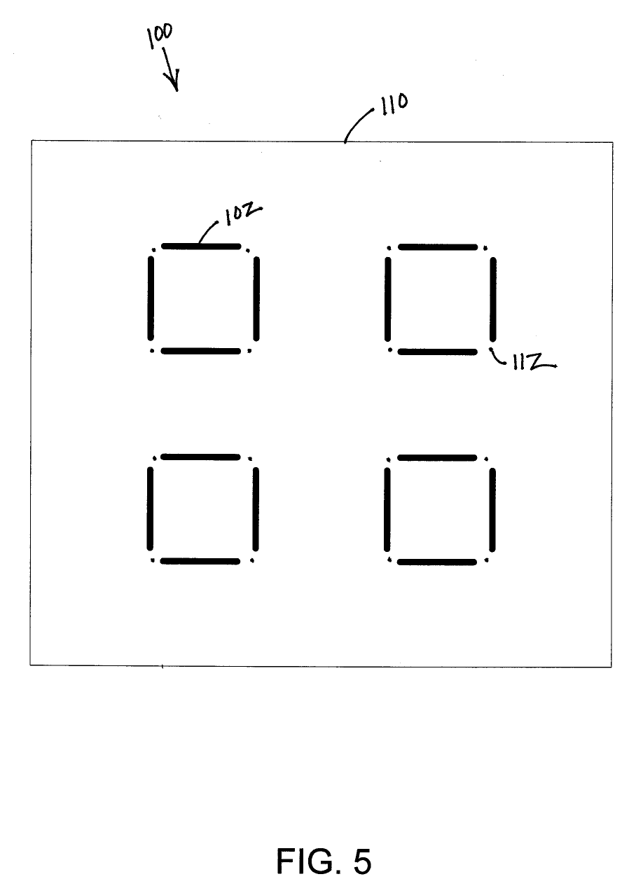

FIG. 5 is a schematic diagram illustrating an exemplary embodiment of a ferrite rod antenna receiver array 100 for use as an electromagnetic receiver coil array for an electromagnetic tracking system. The ferrite rod antenna receiver array 100 comprises a plurality of ferrite rod antennas 102 that are horizontally arranged and attached to a plane 110. Each ferrite rod antenna 102 may include a ferrite rod with at least one turn of an electrically conductive coil wound around the rod as shown in FIG. 2. The ends of the coil form the antenna's leads and may be used to secure the ferrite rod antenna 102 to the plane 110. In an exemplary embodiment, the ferrite rod antenna 102 may further include a capacitor attached to the leads of the coil as shown in FIG. 3.

In the exemplary embodiment shown in FIG. 5, the plurality of ferrite rod antennas 102 are arranged horizontally on the plane 110 to form a receiver array. The ferrite rod antennas 102 are arranged horizontally on the same plane 110, but at different locations, with different orientations, and pointing in different directions. The ferrite rod antennas 102 may be attached to the plane 110 with an adhesive, epoxy, glue, solder, or other attachment mechanism.

In an exemplary embodiment, the plane 110 may be a printed circuit board (PCB). The PCB may be a single layer or a multi-layer PCB. The PCB includes at least one layer with conductors on one or both sides, or even on inner layers, and including a plurality of conductor through holes 112 for mounting the plurality of ferrite rod antennas 102 to the PCB. The PCB may be made of a material that is flexible or rigid. In an exemplary embodiment, the leads of the ferrite rod antennas 102 may be inserted into the conductor through holes 112 and soldered in place to secure the ferrite rod antennas 102 to the PCB.

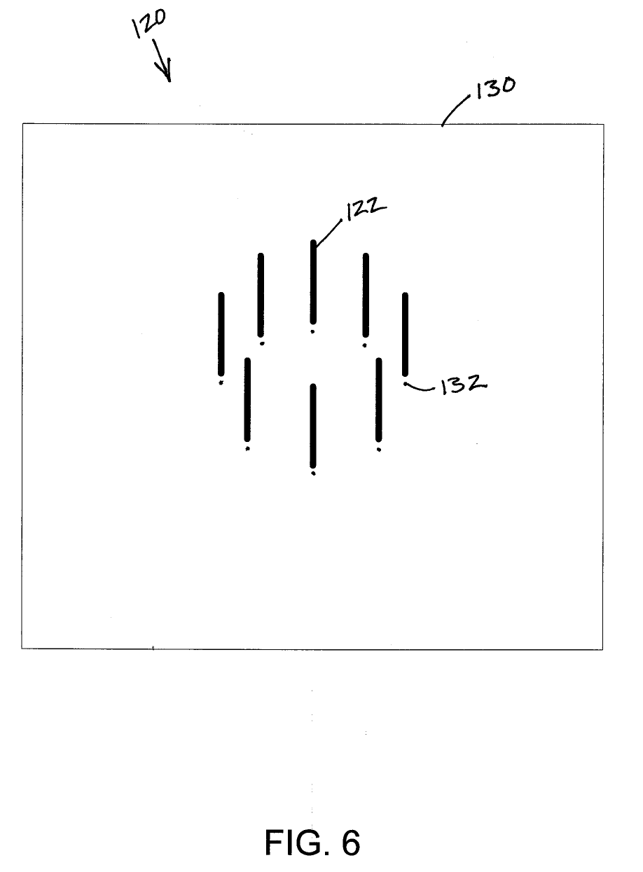

FIG. 6 is a schematic diagram illustrating an exemplary embodiment of a ferrite rod antenna receiver array 120 for use as an electromagnetic receiver coil array for an electromagnetic tracking system. The ferrite rod antenna receiver array 120 comprises a plurality of ferrite rod antennas 122 that are vertically arranged and attached to a plane 130. Each ferrite rod antenna 122 may include a ferrite rod with at least one turn of an electrically conductive coil wound around the rod as shown in FIG. 2. The ends of the coil form the antenna's leads and may be used to secure the ferrite rod antenna 122 to the plane 130. In an exemplary embodiment, the ferrite rod antenna 122 may further include a capacitor attached to the leads of the coil as shown in FIG. 3.

In the exemplary embodiment shown in FIG. 6, the plurality of ferrite rod antennas 122 are arranged vertically on the plane 130 to form a receiver array. The ferrite rod antennas 122 are arranged vertically on the same plane 130, but at different locations and with different orientations. The ferrite rod antennas 122 may be attached to the plane 130 with an adhesive, epoxy, glue, solder, or other attachment mechanism.

In an exemplary embodiment, the plane 130 may be a printed circuit board (PCB). The PCB may be a single layer or a multi-layer PCB. The PCB includes at least one layer with conductors on one or both sides, or even on inner layers, and including a plurality of conductor through holes 132 for mounting the plurality of ferrite rod antennas 122 to the PCB. The PCB may be made of a material that is flexible or rigid. In an exemplary embodiment, the leads of the ferrite rod antennas 122 may be inserted into the conductor through holes 132 and soldered in place to secure the ferrite rod antennas 122 to the PCB.

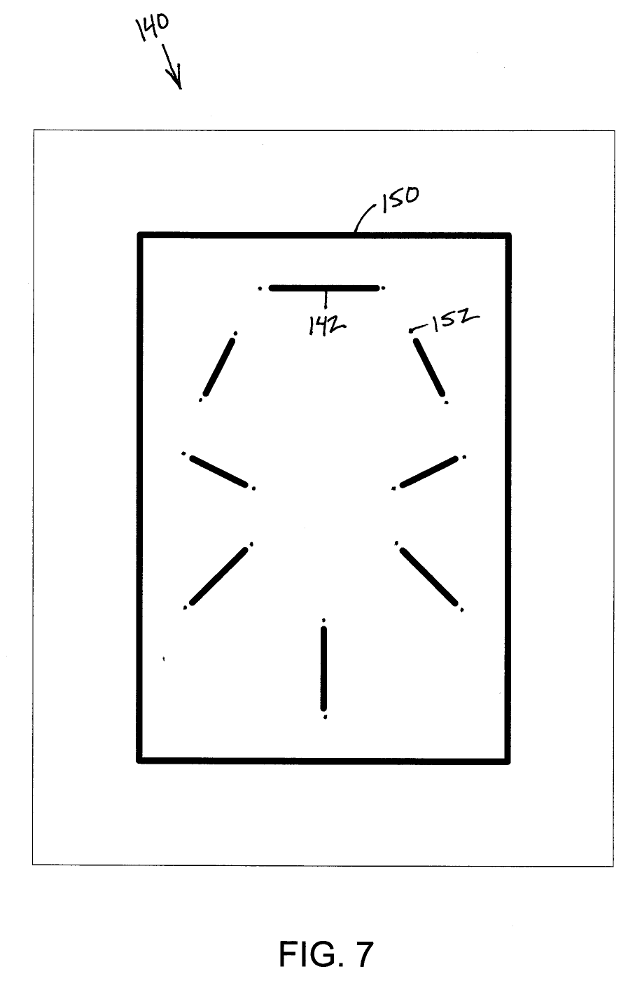

FIG. 7 is a schematic diagram illustrating an exemplary embodiment of a ferrite rod antenna receiver array 140 for use as an electromagnetic receiver coil array for an electromagnetic tracking system. The ferrite rod antenna receiver array 140 comprises a plurality of ferrite rod antennas 142 that are horizontally arranged and attached to an electrically conducting plane 150. Each ferrite rod antenna 142 may include a ferrite rod with at least one turn of an electrically conductive coil wound around the rod as shown in FIG. 2. The ends of the coil form the antenna's leads and may be used to secure the ferrite rod antenna 142 to the plane 150. In an exemplary embodiment, the ferrite rod antenna 142 may further include a capacitor attached to the leads of the coil as shown in FIG. 3.

The electrically conducting plane 150 provides increased electromagnetic field pick-up by the ferrite rod antennas 142 and shields the ferrite rod antennas 142 from possible distortions from a distorter that may be located below the electrically conducting plane 150.

In the exemplary embodiment shown in FIG. 7, the plurality of ferrite rod antennas 142 are arranged horizontally on the electrically conducting plane 150 to form a receiver array. The ferrite rod antennas 142 are arranged horizontally on the same electrically conducting plane 150, but at different locations, with different orientations, and pointing in different directions. The ferrite rod antennas 142 may be attached to the electrically conducting plane 150 with an adhesive, epoxy, glue, solder, or other attachment mechanism.

In an exemplary embodiment, the plane 150 may be a printed circuit board (PCB). The PCB may be a single layer or a multi-layer PCB. The PCB includes at least one layer with conductors on one or both sides, or even on inner layers, and including a plurality of conductor through holes 152 for mounting the plurality of ferrite rod antennas 142 to the PCB. The PCB may be made of a material that is flexible or rigid. In an exemplary embodiment, the leads of the ferrite rod antennas 142 may be inserted into the conductor through holes 152 and soldered in place to secure the ferrite rod antennas 142 to the PCB. In an exemplary embodiment, the PCB may include an electrically conducting plane, such as a copper conductor plane within the inner or outer layers of the PCB.

Several embodiments are described above with reference to drawings. These drawings illustrate certain details of exemplary embodiments that implement the systems, methods and computer programs of this disclosure. However, the drawings should not be construed as imposing any limitations associated with features shown in the drawings.

Certain embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the system might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to various embodiments, those skilled in the art will appreciate that certain substitutions, alterations and omissions may be made to the embodiments without departing from the spirit of the invention. Accordingly, the foregoing description is meant to be exemplary only, and should not limit the scope of the disclosure as set forth in the following claims.

What is claimed is:

1. An electromagnetic tracking system comprising:
at least one transmitter assembly including one or more transmitter coils;
at least one receiver assembly communicating with and receiving signals from the at least one transmitter assembly, the at least one receiver assembly including at least one ferrite rod antenna; and
electronics coupled to and communicating with the at least one transmitter assembly and the at least one receiver assembly for calculating the position and orientation of an object to be tracked.

2. The electromagnetic tracking system of claim 1, wherein the one or more ferrite rod antenna is configured to provide a low profile electromagnetic receiver coil array.

3. The electromagnetic tracking system of claim 1, wherein the object to be tracked is a medical device, implant or instrument.

4. The electromagnetic tracking system of claim 1, wherein the at least one electromagnetic transmitter assembly is attached to a medical device, implant or instrument to be tracked and the at least one electromagnetic receiver assembly is positioned within at least one electromagnetic field generated by the at least one electromagnetic transmitter assembly to track the position and orientation of the medical device, implant or instrument.

5. The electromagnetic tracking system of claim 1, wherein the at least one electromagnetic receiver assembly 14 may be attached to a medical device, implant or instrument to be tracked and the at least one electromagnetic transmitter assembly 12 may generate at least one electromagnetic field to be received by the at least one electromagnetic receiver assembly to track the position and orientation of the medical device, implant or instrument.

6. The electromagnetic tracking system of claim 1, wherein the one or more ferrite rod antenna includes a ferrite rod with at least one turn of an electrically conductive coil wound around the ferrite rod.

7. The electromagnetic tracking system of claim 1, wherein the one or more ferrite rod antenna includes a ferrite rod with at least one turn of an electrically conductive coil wound around the ferrite rod and a capacitor coupled to the coil.

8. The electromagnetic tracking system of claim 1, wherein the one or more ferrite rod antenna is positioned on a plane.

9. The electromagnetic tracking system of claim 8, wherein the one or more ferrite rod antenna is positioned horizontally on the same plane.

10. The electromagnetic tracking system of claim 8, wherein the one or more ferrite rod antenna is positioned vertically above the plane.

11. The electromagnetic tracking system of claim 8, wherein the plane is an electrically conductive plane.

12. The electromagnetic tracking system of claim 8, wherein the plane is a printed circuit board.

13. The electromagnetic tracking system of claim 1, wherein the one or more transmitter coil is a ferrite rod antenna.

14. A receiver coil array for an electromagnetic tracking system comprising a plurality of ferrite rod antennas positioned on a plane at different locations, with different orientations, and pointing in different directions.

15. The receiver coil array of claim 14, wherein each ferrite rod antenna of the plurality of ferrite rod antennas includes a ferrite rod with at least one turn of an electrically conductive coil wound around the ferrite rod.

16. The receiver coil array of claim 14, wherein the plurality of ferrite rod antennas are horizontally arranged and attached to a plane.

17. The receiver coil array of claim 16, wherein the plane is a printed circuit board.

18. The receiver coil array of claim 14, wherein the plurality of ferrite rod antennas are horizontally arranged and attached to an electrically conducting plane.

19. The receiver coil array of claim 18, wherein the plane is a printed circuit board.

20. The receiver coil array of claim 14, wherein the plurality of ferrite rod antennas are vertically arranged and attached to a plane.

21. The receiver coil array of claim 20, wherein the plane is a printed circuit board.

22. The receiver coil array of claim 14, wherein the plurality of ferrite rod antennas are vertically arranged and attached to an electrically conducting plane.

23. The receiver coil array of claim 22, wherein the plane is a printed circuit board.

24. The receiver coil array of claim 14, wherein the plurality of ferrite rod antennas are all positioned on the same plane.

25. A transmitter coil array for an electromagnetic tracking system comprising at least one ferrite rod antenna.
